(19) United States
(12) Patent Application Publication
(10) Pub. No.: US 2011/0188036 A1
(43) Pub. Date: Aug. 4, 2011

(54) MONOCHROMATIC MEASUREMENT SYSTEM

(75) Inventors: Ding-Hsiang Pan, Kuei-Shan Hsiang (TW); Hsin-Yueh Sung, Kuei-Shan Hsiang (TW); Tsung-Hsien Ou, Kuei-Shan Hsiang (TW); Yu-Hsuan Lin, Kuei-Shan Hsiang (TW); Hung-Ta Chien, Kuei-Shan Hsiang (TW)

(73) Assignee: CHROMA ATE INC., Kuei-Shan Hsiang (TW)

(21) Appl. No.: 13/019,254

(22) Filed: Feb. 1, 2011

(30) Foreign Application Priority Data
Feb. 2, 2010 (TW) 99103009

(51) Int. Cl. G01J 3/42

(52) U.S. Cl. 356/320

(57) ABSTRACT

The present invention relates to a monochromatic measurement system. The system mainly includes a monochromator, a light-detecting device and a filter device. The monochromator functions to split light under test into respective light beams with different wavelengths. The filter device modulates the transmission efficiency of the respective light beams, so that the wavelengths of the light beams to which the light-detecting device displays a better response have a lower transmission efficiency while the wavelengths of the light beams to which the light-detecting device displays a lower response have a higher transmission efficiency. The response values measured by the light-detecting device with respect to different wavelength intervals are normalized accordingly. The measurement errors attributed to the measurement precision of the instrument and the environmental noise are independent from the variation of wavelength. The reliability of the measurement instrument is elevated.

### FIELD OF THE INVENTION

The present invention relates to a measurement system, and more particularly, to a spectrophotometric measurement system capable of normalizing the responses to different wavelengths of light to thereby minimize the difference among the measured values for the respective wavelengths of light.

### DESCRIPTION OF THE RELATED ART

With the development of science and technology, lots of display devices with improved performance are booming in the market. Key points that have to be taken into account for evaluating the display devices include the white balance, color rendering property and chroma distribution of the light sources and the images displayed. Such being the case, various tests are carried out at various stages during the manufacture of a display device, so as to ensure the quality of individual light sources, light sources modules and the finished display device. Among the tests, spectrophotometric analysis is an important one. In addition, taking advantage of the fact that every chemical has its own characteristic emission and absorbance spectra, the spectrophotometric analysis is applicable to determine whether a chemical of interest is present in a gaseous or aqueous specimen.

FIG. 1 shows a conventional spectrophotometer, which includes a monochromator 1 and a light-detecting device 2. The monochromator 1 includes a slit 11 for filtering stray light from an incident light, a collimator 12 for collimating the light passing through the slit 11, a grating 13 for receiving the collimated light and splitting it into a plurality of light beams with different wavelengths, and a focusing mirror 14 used for focusing the light beams from the grating 13 onto separate positions of the light-detecting device 2 where the spectral distribution of the incident light is determined.

FIG. 2 shows the response values of a conventional light-detecting device to visible light with wavelengths from 380 nm to 780 nm. It can be seen from FIG. 2 that the light-detecting device possesses a relatively poor response coefficient to light with a wavelength of 380 nm˜480 nm (blue and near-ultraviolet light) or 580 nm˜780 nm (red and near infrared light), which would be only about 30% after normalization if the response coefficient to light with a wavelength of 480 nm˜580 nm is set to be 100%.

In general, data collected with respect to the red and blue regions are compensated based on the related response coefficients. For example, in the case where the response coefficient is 30%, the measured value is multiplied by a factor of 3.33 with an amplifier. Measurement errors and environmental noise are normally considered independent from the variation of wavelength. However, in the case where three response values 31, 32, 33 are measured in different wavelength intervals as shown in FIG. 3, the response values 31, 33 measured in the wavelength intervals with a lower response coefficient will be compensated for and multiplied by a factor of 3.33, along with their measurement errors and noises 311, 331. While the amplified response values 31′, 33′ are as great as the response value 32, the amplified error and noise values thereof 311′, 331′ are 3.3 times greater than the error and noise value 321. As a result, the measurement precision of the light-detecting device will fluctuate from one wavelength interval to another and this will significantly reduce the reliability of the machine.

Therefore, there is a need for a system with enhanced linearity and precision of measurement that can collect normalized response values for respective wavelengths of light, without significantly increasing the cost factor.

### SUMMARY OF THE INVENTION

Accordingly, an object of the present invention is to provide a spectrophotometric measurement system capable of normalizing the responses to respective wavelengths of light by modulating the transmission efficiency of the respective wavelengths of light.

Another object of the invention is to provide a spectrophotometric measurement system capable of normalizing the responses to respective wavelengths of light to thereby enhance the precision of measurement.

The present invention therefore provides a monochromatic measurement system for measuring intensities of respective wavelengths of an incident light. The system comprises a monochromator for splitting the incident light into respective light beams with the respective wavelengths; a light detector array displaying different first responses to the respective light beams with the respective wavelengths; and a response-normalizing filter device disposed at a light incident side of the light detector array and having second responses to the respective light beams which are complementary to the first responses of the light detector array to the respective light beams.

By virtue of being provided with the response-normalizing filter device, the monochromatic measurement system disclosed herein is capable of modulating the transmission efficiency of the respective light beams, so that the wavelengths of the light beams to which the light detector array displays a better response have a lower transmission efficiency while the wavelengths of the light beams to which the light detector array displays a lower response have a higher transmission efficiency. The response values measured by the light detector array with respect to different wavelength intervals are normalized accordingly. As a result, the measurement precision for respective wavelengths of light is elevated with significantly increasing the cost factor of the system. Furthermore, the invention can be simply practiced on the measurement instruments that have been already installed in the production lines during maintenance and calibration activities. The invention achieves the objects described above accordingly.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is a schematic diagram of a conventional spectrophotometer, in which an incident light is split into a plurality of light beams with different wavelengths;

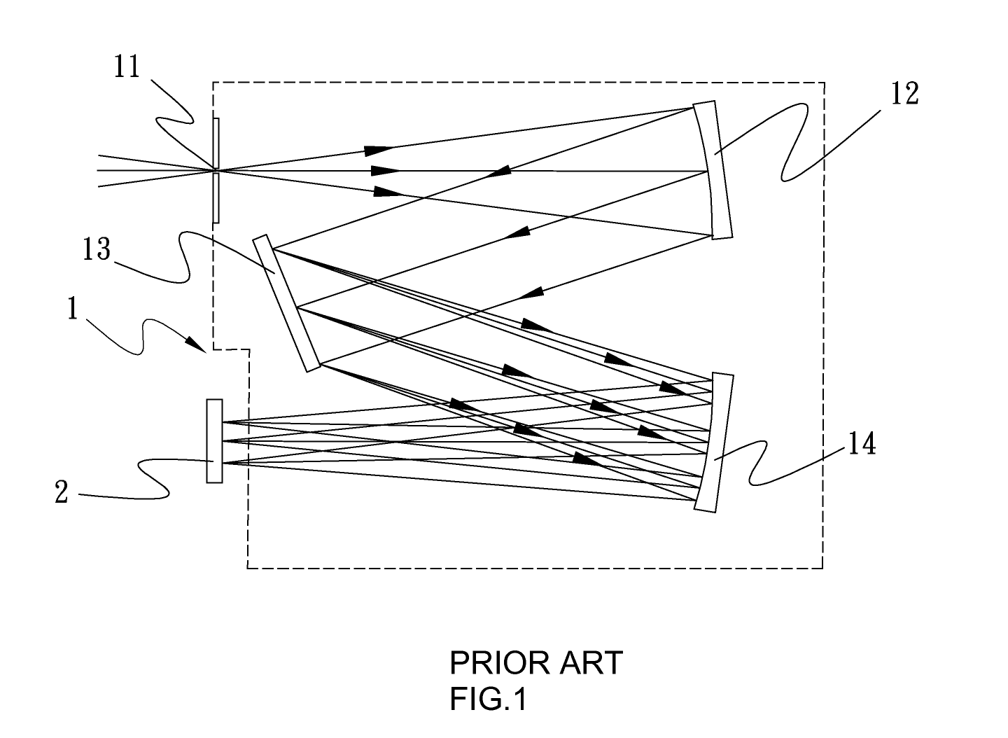

FIG. 2 is a plot showing the relationship between the response value of the conventional spectrophotometer of FIG. 1 versus the wavelength of incident light beams;

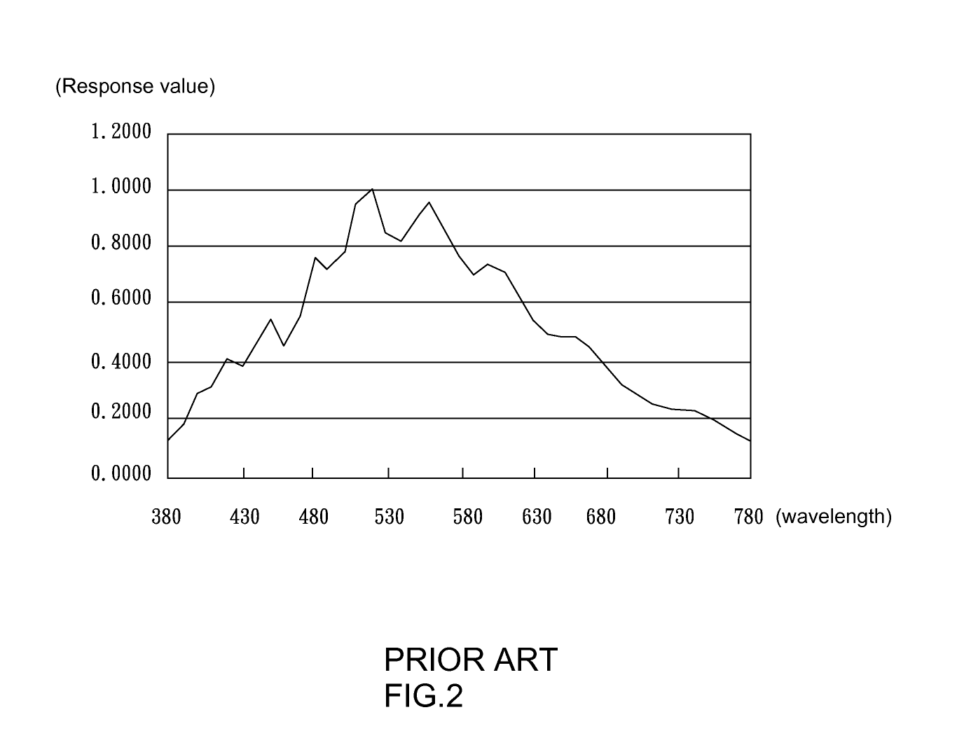

FIG. 3 is a plot illustrating measurement errors and noises that occur during the determination of response values to the respective wavelengths of light;

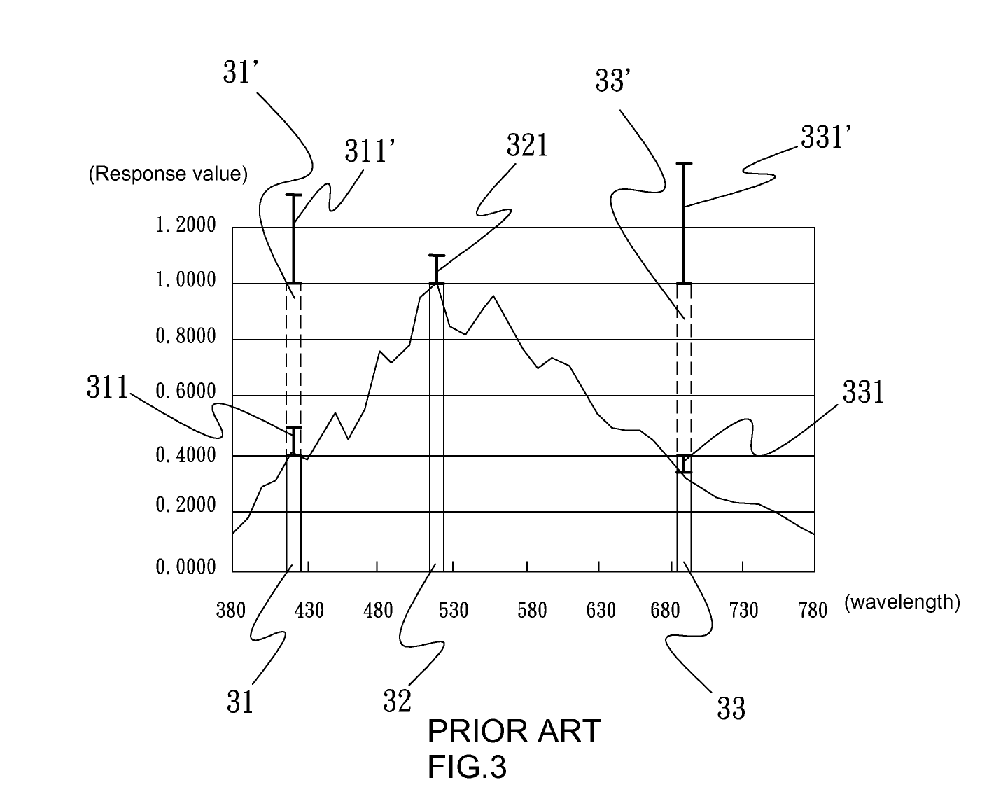

FIG. 4 is a schematic diagram of monochromatic measurement system according to the first preferred embodiment of the invention, in which an incident light is split into a plurality of light beams with different wavelengths;

FIG. 5 is a plot showing the relationship between the response value of the monochromatic measurement system of FIG. 4 versus the wavelength of incident light beams;

FIG. 6 is a diagram showing that the response values of FIG. 5 are normalized; and

FIG. 7 is a schematic diagram of monochromatic measurement system according to the second preferred embodiment of the invention, in which an incident light is split into a plurality of light beams through a transmission grating.

### DETAILED DESCRIPTION OF THE INVENTION

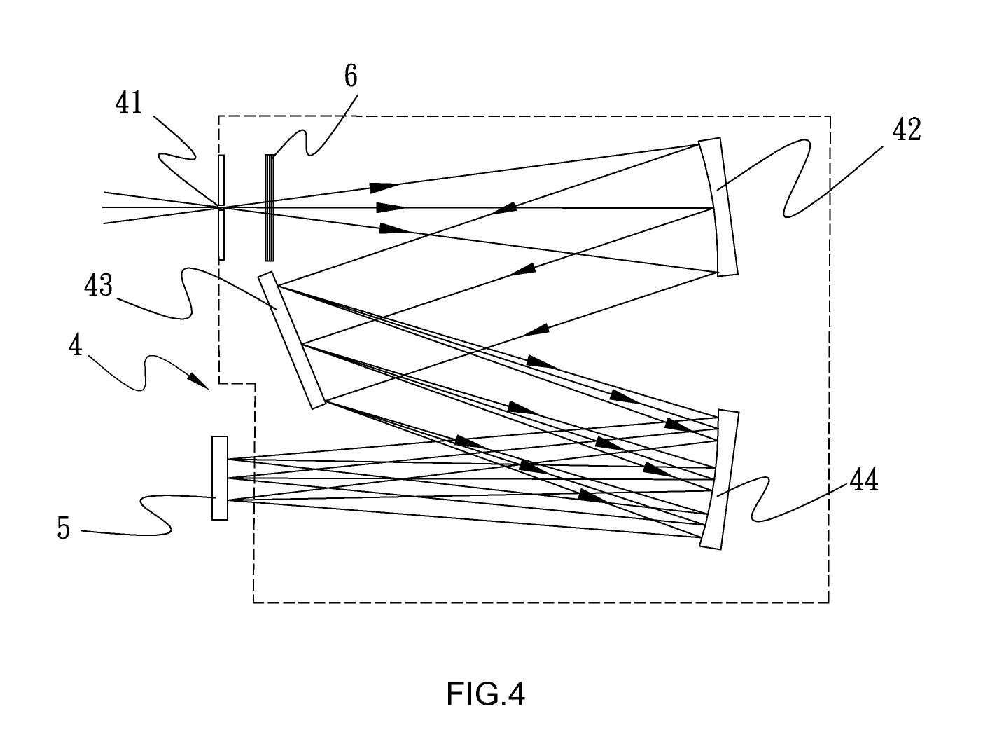

According to the first preferred embodiment of the invention shown in FIG. 4, a spectrophotometer comprises a monochromator 4, a light detector array 5 and a response-normalizing filter device 6. The monochromator 4 includes a slit 41, a collimator 42, a diffraction grating device 43 and a focusing mirror 44. The slit 41 of the monochromator 4 is used to eliminate stray light and allow incident light with a narrow band of wavelengths from a tested sample to pass therethrough. According to this embodiment, the response-normalizing filter device 6 disposed immediate downstream to the slit 41. The response-normalizing filter device 6 is made of plastic or glass material and is preferably composed of a set of glass filters. The filtered incident light is reflected by the collimator 42, so that the incident light is collimated and directed to the diffraction grating device 43. In this embodiment, the diffraction grating device 43 is configured in the form of a reflective grating that splits the collimated light into a plurality of light beams with different wavelengths. The light beams are then collected by the focusing mirror 44 and refocused on separate positions of the light detector array 5, where an one-dimensional array of light detectors are aligned to determine the intensity of the respective light beams.

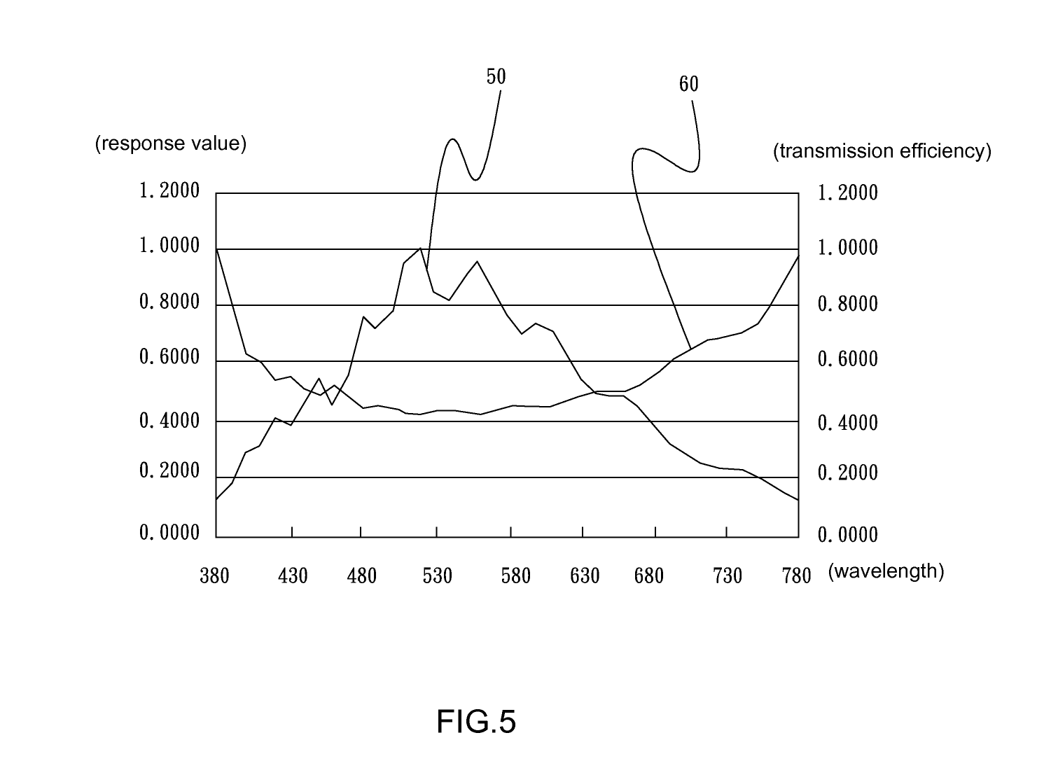

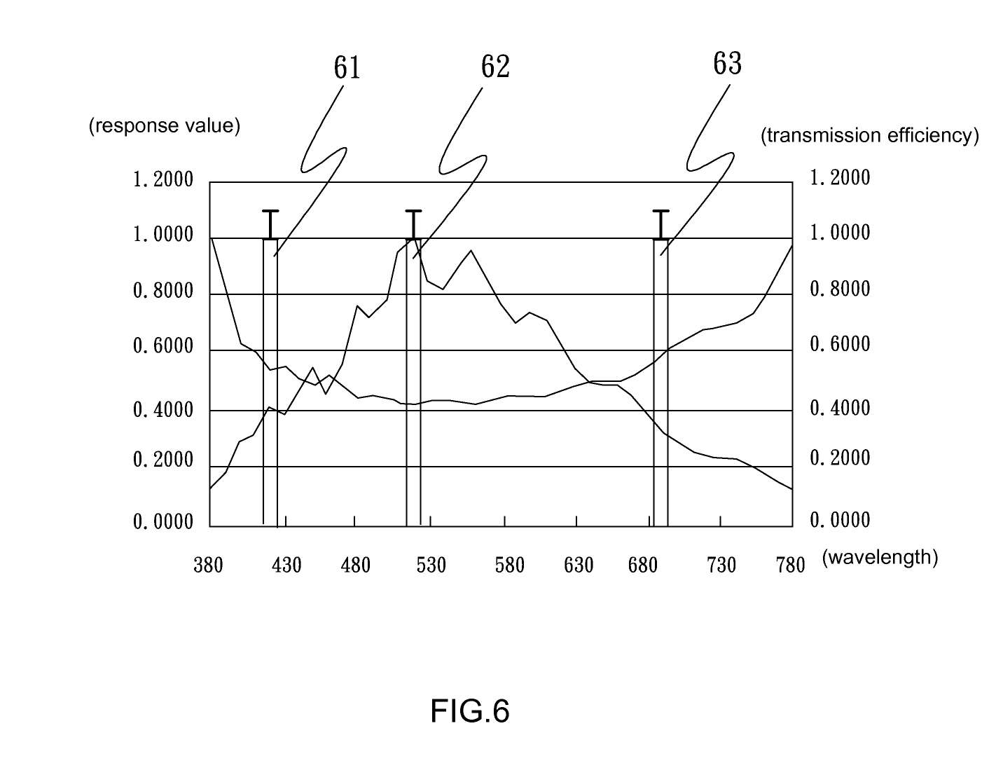

Now referring to FIGS. 5 and 6, the curve 50 represents the response curve of the light detector array 5 to a spectral distribution of light. The response-normalizing filter device 6 is designed to partially block the wavelengths of light to which the light detector array 5 has a better response, so that the incident light in the wavelength interval with a higher response coefficient has a relatively poor transmission efficiency through the response-normalizing filter device 6. In comparison, the incident light in the wavelength intervals with a lower response coefficient is allowed to have greater transmission efficiency. The transmission efficiency of light is plotted against wavelengths to constitute the curve 60 in FIG. 5. That is to say, the amount of light in the wavelength interval of 410 nm˜690 nm with a greater response coefficient is diminished due to a decrease in transmission through the filter device 6, whereas the amounts of light in the wavelength intervals of 380 nm˜410 nm and 690 nm˜780 nm with lower response coefficients are maintained at the original levels.

As shown in FIG. 6, since the wavelengths of light to which the light detector array 5 has a better response are counterbalanced in quantity by reducing their transmission through the filter device 6, the response values 61, 62, 63 measured at the light detector array 5 with respect to different wavelength intervals are normalized to a suitable degree. Meanwhile, the measurement errors are attributed to the measurement precision of the instrument used and the environmental noise and, thus, are independent from the variation of wavelength. The reliability of the measurement instrument is elevated accordingly. Even in the case where the light detector array 5 is interfered with by measurement errors and environmental noises during receipt of light, resulting in a relative increase in the noise level compared with the decreased amount of light passing through the filter device 6, the noises normally occur in a random manner and are present predominantly in the form of AC components during measurement, in contrast to the incident light which is mainly in the form of DC components. The noises are counterbalanced upon accumulation over time to prevent a reduction in the signal-to-noise ratio.

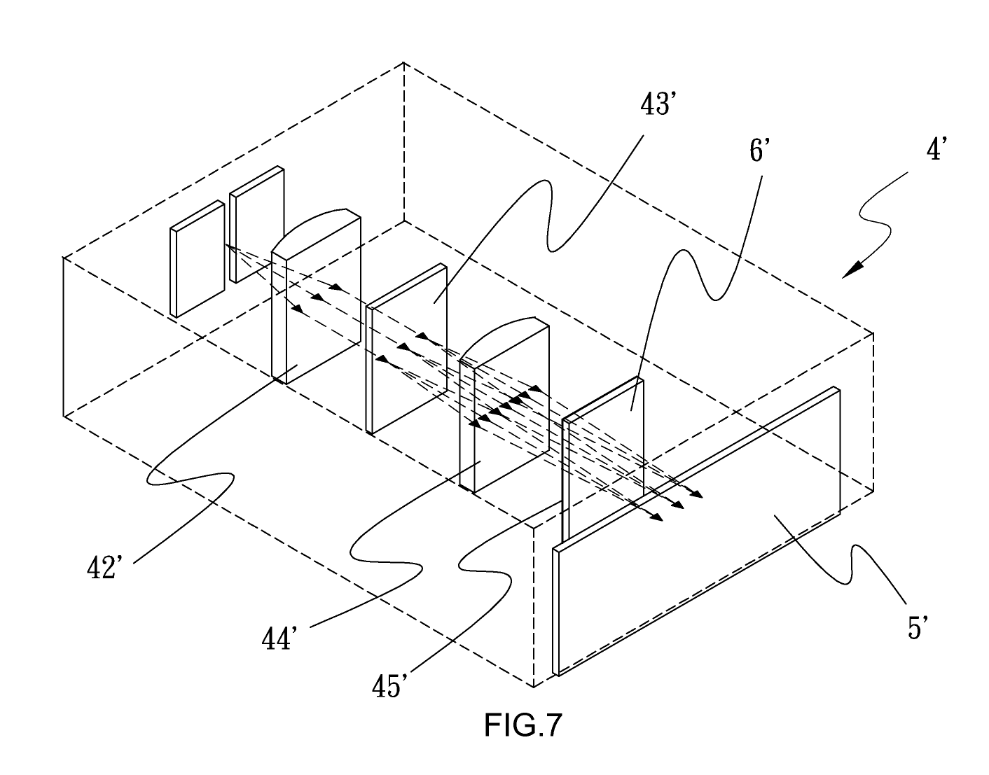

It is apparent to those having ordinary skill in the art that the optical elements described in the embodiment above can be substituted by like elements. According to the second embodiment of the invention shown in FIG. 7, a collimator 42′ and focusing mirror 44′ are configured as a transparent concave mirrors or a set of lenses, and a diffraction grating device 43′ is designed to be in the form of a transmission grating that splits incident light into a plurality of light beams with different frequencies. In this embodiment, a response-normalizing filter device 6′ is a multi-coated filter 45′ disposed upstream to a light detector array 5′. The light detector array 5′ is made up of a number of light detectors aligned in a two-dimensional array to detect the light beams from the monochromator 4′. The noise interference is overcome upon accumulation in a spatial direction, thereby maintaining a satisfactory signal-to-noise ratio.

In contrast to the prior art, the inventive monochromatic measurement system compensates for the unevenness in the response of the light-detecting device to respective wavelengths of light incident thereon by modulating the transmission efficiencies of the respective wavelengths of light to normalize the measured values for the respective wavelengths of light. By virtue of the structural modification disclosed herein, the measurement precision of the system is successfully enhanced without significantly increasing the cost factor for the system. Furthermore, the invention can be simply practiced on the measurement instruments that have been already installed in the production lines during maintenance and calibration activities. Therefore, there is no need to replace the installed instruments with new ones.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

What is claimed is:

1. A monochromatic measurement system for measuring intensities of respective wavelengths of an incident light, the system comprising:
a monochromator for splitting the incident light into respective light beams with the respective wavelengths;
a light detector array displaying different first responses to the respective light beams with the respective wavelengths; and
a response-normalizing filter device disposed at a light incident side of the light detector array and having second responses to the respective light beams which are complementary to the first responses of the light detector array to the respective light beams.

2. The monochromatic measurement system according to claim 1, wherein the monochromator comprises:
a slit permitting the incident light to pass therethrough;
a collimator for collimating the incident light and directing the collimated light to a diffraction grating device;
a diffraction grating device for receiving the collimated light that passes through the slit and splitting it into the respective light beams with different wavelengths; and
a focusing mirror for focusing the respective light beams from the diffraction grating device onto the light detector array.

3. The monochromatic measurement system according to claim 2, wherein the focusing mirror is a concave mirror.

4. The monochromatic measurement system according to claim 2, wherein the focusing mirror is a lens.

5. The monochromatic measurement system according to claim 2, wherein the diffraction grating device is a transmission grating.

6. The monochromatic measurement system according to claim 2, wherein the diffraction grating device is a reflective grating.

7. The monochromatic measurement system according to claim 2, wherein the collimator is a concave mirror.

8. The monochromatic measurement system according to claim 2, wherein the collimator is a lens.

9. The monochromatic measurement system according to claim 1, wherein the response-normalizing filter device comprises at least one film-coated filter.

10. The monochromatic measurement system according to claim 1, wherein the light detector array is an array of light detectors aligned in one dimension.
